(19) United States
(12) Patent Application Publication
(10) Pub. No.: US 2004/0094471 A1
(43) Pub. Date: May 20, 2004

(54) Lint catching bag

(76) Inventor: Terry R. Cole, St. Louis, MO (US)

Correspondence Address: Paul M. Denk, Ste. 170, 763 S. New Ballas Road, St. Louis, MO, 63141, US

(21) Appl. No.: 10/704,962

(22) Filed: Nov. 10, 2003

Related U.S. Application Data
(60) Provisional application No. 60/427,378, filed on Nov. 19, 2002.

(51) Int. Cl. B01D 29/11

(52) U.S. Cl. 210/460; 210/499

(57) ABSTRACT

A lint catching bag for attachment to the discharge end of the discharge hose for a washing machine; the upper end of the lint bag includes a drawstring, or elastic device that gathers the upper end of the bag, as it is placed over the end of the discharge hose, and a clamp may be fastened in place, to firmly tighten and secure the bag to the end of the hose, as the two are located in proximity with a sewer drain, or deposited downwardly into the drain pipe, for discarding of the discharge water from the washing machine, while capturing lint and preventing its entrance into the sewer line.

### BACKGROUND OF THE INVENTION

This invention relates to a means for catching lint exiting from a clothes washer, as when the wash water is being drained from the washing machine.

As everyone well knows, clothing has long been automatically washed, and dried, through the combination clothes washer and dryer. This has been en vogue for over fifty years. For about the same length of time, this system for cleaning clothes has been automated.

In addition, and more specifically, one minor but significant detriment relating to the washing of clothes, in the washer, and then their drying in the dryer, is that an abundance of lint is generated during the cycle. Normally, with respect to the dryer, various types of filters have been built into the dryer, in an effort to try to capture the lint from the circulating heated air, as it moves through the dryer under the force of its blower, and likewise, there are even various types of screens, or the like, that attempt to catch the lint as it passes through the conduit as it is vented exteriorly to the atmosphere. Efforts have been made to resolve the lint problem, particularly with respect to the drying operation.

But, with regard to the washing machine, it does not appear that anything has been patently tried in an effort to capture the lint. Most significantly, a large amount of the lint is carried by the wash water, during the washing cycle, and then when the washing cycle is completed, and just before spin drying, the wash water is drained to a basin, floor drain, or the like, for discharge. One major problem with this operation, is that there is a large amount of lint that is carried in the wash water, and when it gets into the underground drain and sewer system, as in the lateral lines leading out to the main sewer lines, that lint can have a tendency to build up, cause clogging, and even block up household sewage, in the most severe case. Nevertheless, such has occurred.

Through the efforts of the invention as described herein, a concept for catching the lint from the wash water, as it is discharged, is the principal effort of this invention.

### SUMMARY OF THE INVENTION

This invention relates generally to a filtering operation, and more specifically pertains to the capturing of lint from the washing machine wash water as it is discharged into the drain.

This invention contemplates the usage of a lint capturing device that is secured to the end of the discharge hose for the clothes washer and there at, provide means for capturing lint during the discharge cycle.

More specifically, the lint catcher of this invention includes a foraminous or net type of bag, which may be made of a variety of materials to be hereinafter described, and which is tied or otherwise secured to the end of the discharge hose, after it integrally loops around its gooseneck, with the downwardly directed end of the hose, with its connected filter bag, then being located within, or in proximity or surrounded by, the drain, as it drains away the soiled washing machine water, as it is automatically discharged, after performance of a washing cycle.

The lint catcher of this invention comprises a foraminous type of bag, that has small enough gage for its openings, so as to be able to capture and hold the lint being conveyed by the discharging water, but at the same time, the porosity of the bag will allow the water to freely discharge, into the drain, and flow away for removal. The bag, at its upper end, may include a drawstring, or other type of gathering means, so that it can be tightly grasped upon the end of the discharge hose, and either held thereat by means of a drawstring, or perhaps even held more securely in place, as through usage of a clamp, of the metal or polymer type, that can be tightly screwed or otherwise clamped into position, to hold the bag permanently upon the end of the discharge hose, for repeat usage, until such time as the bag becomes filled to capacity with lint, after continuous usage. At that time, the clamp or other holding means can be removed, the bag's drawstring can be loosened, and the entire lint collection can be discarded, in any manner suitable to the home or commercial cleaning establishment owner.

As is well known in the art, any time heavy clothing, deep pile rugs, are cleaned in a washing machine, a voluminous amount of lint is generated, and the purpose of this invention is to provide for an immediate capture of such lint, so as to prevent its entry into the drain, and effect any deleterious activity therein, as can be readily understood. In addition, the bag of this invention may be made of a highly resistant material, even those types of polymers that may be resistant to bleach or other corrosive liquids, so as to resist any accelerated deterioration of the lint bag, during its usage.

The lint catcher of this invention is designed to provide exactly as the name implies, and that is to capture the lint, to allow clear but soiled water to enter into the drain, and to allow the captured lint to be discarded, as other refuse, and not pass through the sewage system.

It is, therefore, the principal object of this invention to provide a lint catcher that can be promptly adhered and connected to the end of a discharge hose of a washing machine, to perform just that, the capture of lint.

Still another object of this invention is to provide a lint bag that can be immediately connected for installation.

Still another object of this invention is to provide a lint capturing means that can be readily removed, and disposed of, after repeat usage.

Yet another object of this invention is to provide a lint catcher, in the form of a foraminous bag that is designed to resist deterioration when exposed to any caustic material, such as bleach, or other alkaline, or even acidic tainted fluids. These and other objects may become more apparent to those skilled in the art upon review of the summary of the invention as provided herein, and upon undertaking a study of the description of its preferred embodiment, in view of the drawings.

### BRIEF DESCRIPTION OF THE DRAWINGS

In referring to the drawings, FIG. 1 provides a front view of the lint catching bag of this invention;

FIG. 2 provides a view of the bag, as shown in FIG. 1, after installation and repeat usage, and approximately halfway filled with collected lint;

FIG. 3 shows a schematic of the bag as it attaches, at its upper end, to the end of the discharge hose;

FIG. 4 shows the arrangement of the washing machine, its discharge hose, and how the upper end of the discharge hose, with its bag, is inserted into the sewer drain during usage;

FIG. 5 shows the upper end of the discharge hose, for the washing machine, and to which the lint catching bag attaches; and

FIG. 6 shows a schematic of how the discharge hose extends from the rear of the washing machine, as known in the art.

### DESCRIPTION OF THE PREFERRED EMBODIMENT

In referring to the drawings, FIG. 1 discloses the lint catching bag of this invention. The bag 1, as shown, and in the preferred embodiment, comprises a nylon mesh bag of approximately ten to twelve inches in length, approximately three inches in width, and which is opened into a diameter of approximately two and a half inches, when employed. The upper end of the bag, as at 2, includes a drawstring that aids in its attachment to the end of the discharge hose, for the washing machine, as to be explained.

Two variations on what has just been described, requires comment. Initially, the bag may be fabricated of a variety of materials, can be made of strands of woven cloth or string, into the mesh form, or can be fabricated from a polymer, such as the nylon as described herein, or even perhaps from a specially designed polymer that will resist deterioration when exposed to alkaline or caustic materials, such as bleach, normally used within the washer water of a washing machine. In particular, this may be preferred where the bag of this invention may be employed within a commercial coin operated laundromat, or a cleaning establishment that utilizes the lint catching bag of this invention.

The second point to be reviewed is that the drawstring is of assistance when initially tying the bag to the end of the discharge hose. Obviously, under more repeat usage conditions, one of those types of polymer or metal clamps, as known in the art, where a screw is tightened to decrease the diameter of the clamp, as the screw turns, can be used, or any other type of clamping device, such as the type that utilize a nut and bolt, for clamping the ends of the clamp together and reducing their dimension, can be employed. One such clamp can be seen at 3 located inside of the lint catching bag of this invention.

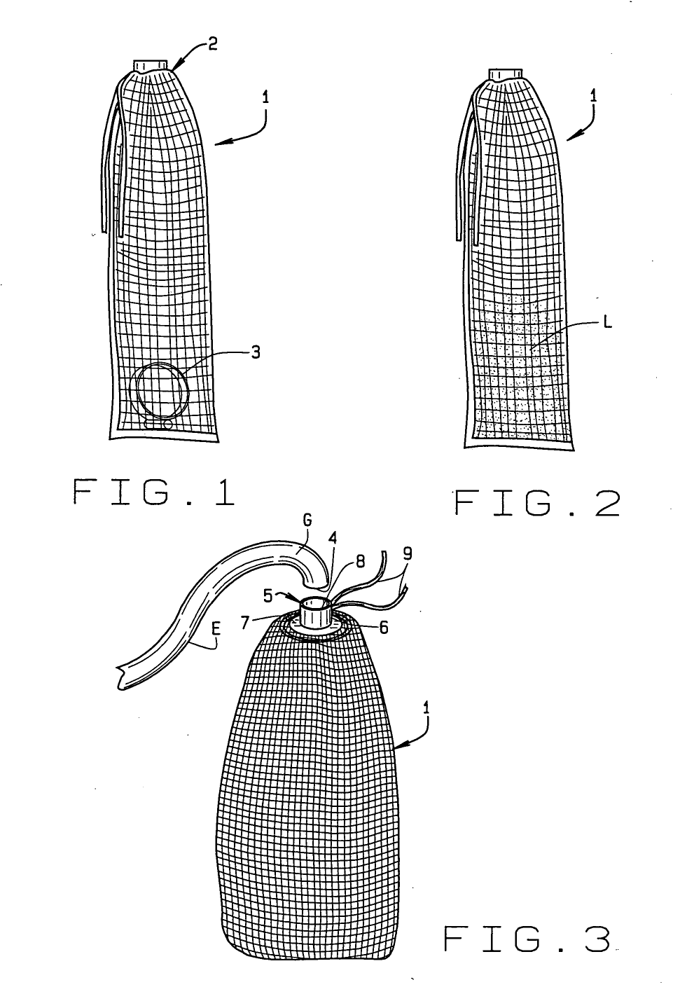

FIG. 2 shows the lint bag of this invention, after repeat usage, for a prolonged period of time, and as can be seen, the bag 1 is filled half to capacity with a collection of captured lint L, as can be noted.

A preferred construction for the bag of this invention is also shown in FIG. 3. Initially, as noted, and as can be seen in FIG. 6, the washing machine W normally has its discharge hose H extending from its back end. The upper end E forms a goose neck G, which extends down to the discharge end 4 of the shown hose.

As a further modification to the lint catching bag 1 of this invention, there may be provided a coupling 5, which may-be formed having an integral sleeve 6, with a flange 7 at its lower end, and obviously incorporating a flow chamber 8 entirely through the coupling. Then, the bag, and its drawstring 9 can be attached over the flange 7 of the coupling, and the sleeve 6 slid up onto the end of the discharge hose, and clamped into position through usage of one of clamps as previously defined. Thus, when installed in that manner, the entire lint catching bag is ready for usage, it can be arranged over the floor drain, or slid downward into the drain pipe, for directing the washing water to the sewer line, for removal.

FIG. 5 shows the upper end of the drain pipe, as at G, and how its lower end, might flair, as at F, thereby providing a slight bevel, as at 10, and over which the drawstring of the lint catching bag may locate, and tighten into position, and firmly held in place, with the bevel 10 preventing the downward sliding of the gathered upper end of the bag, once installed. In addition, one of those spring clamps 11 might be used for aiding in the holding of the upper end of the lint catching bag in place, once installed.

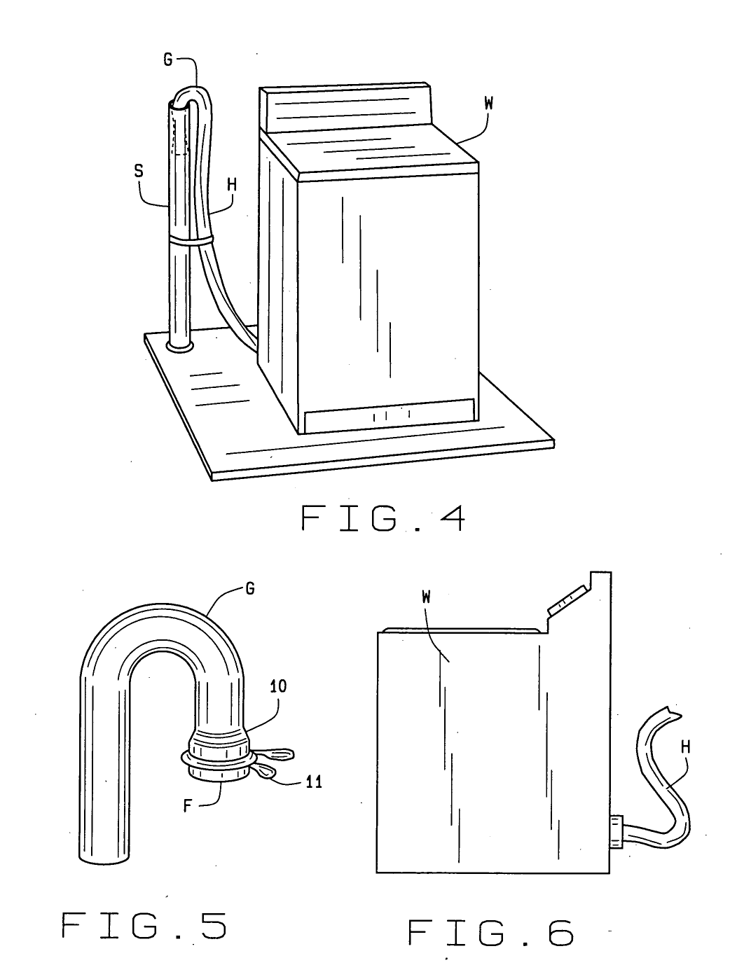

The method for installing one of the lint catching bags of this invention should be rather obvious, after reviewing the description of the preferred and modified embodiments of this invention, as previously reviewed. But, in addition, in referring to FIG. 4, the washing machine W, with its drain hose H, are readily disclosed, with the upper end or goose neck G of the drain hose being located into the upper end of the sewer drain S, as can be noted. This installation of the drain hose into the sewer drain will be performed after the lint catcher has been installed onto the end 4 of the discharge hose, with the combination of the bag, and the downwardly extending part of the hose goose neck, extending down into the drain pipe S, as can be understood. All one would need to do to achieve installation of the lint catching bag of this invention is simply to open the bag, upon its purchase, and remove its support ring, such as one of the rings 3. Once slides the support ring up onto the lower end 4 of the discharge hose. One that inserts the lower end of the hose into the upper end of the bag, with the drawstrings fully opened. Then, the drawstrings are gently pulled into closure. At this stage, the support ring can be carefully slid downward, so that it is even with the top of the bag, and embraces the upper end of the drawn bag, and then the support ring is tightened, in a manner as previously described. At this stage, the bag should be firmly held to the discharge end of the hose, and cannot be pulled free, even as water is forcefully being discharged from the hose, as during the draining of the clothes washer. The combination of the bag, and the upper end of the hose, is inserted down into the drain, and if properly installed, the bag itself is not even seen, as can be noted in FIG. 4.

Hence, with usage of this invention, the concept of capturing lint from the washing machine discharge, and preventing a buildup of such lint of debris in the drain pipes, or the sewer line, are obviated. The lint catcher of this invention protects plumbing by keeping foreign material from clogging the drains. The fine mesh screen will capture all material larger than one millimeter in size. The lint catcher is designed to capture lint, string, paper, or other debris which may become freely submerged within the washing machine water, as it is being discharged, after a washing cycle. Normally, when the lint catcher of this type is used for three months, more or less, it will generally fill to some capacity, and require its removal, and replacement, but providing the homeowner with the security that the sewer pipes have not been ladened with the type of lint material that may clog the sewers, after prolonged usage of the washing machine.

The lint catching bag of this invention can be readily used, installed, and adapted for usage by the homeowner, the apartment building owners, hotels, nursing homes, laundromats, commercial cleaning establishments, or anyone who uses a washing machine. The specific dimensions of this particular lint catching bag may be anywhere from 12 to 16 inches in length, and approximately 2 to 3 inches in width, so that it fits snuggly within the upper end of the drain pipe, or plumbing, conveniently captures any lint passing therethrough, but readily allows any of the water to freely flow into the drain pipe, for discharge.

Variations or modifications to the subject matter of this invention may occur to those skilled in the art upon review of the invention as described herein. Such variations if within the scope of the spirit of this development are intended to be encompassed within the concept of this invention, for which patent protection is sought herein. The descriptions of the preferred embodiment, and the depiction of the invention in the drawings, are set forth for illustrative purposes only.

1. Lint catching bag for use in conjunction with a clothes or other material washing machine provided for capturing lint to prevent its entrance into the drain pipe and plumbing in a residence or other establishment, said lint catching bag having a substantial length and circumference to provide a capacity for collecting any lint draining from the washing machine, a clamp attachable to the end of the washing machine drain and where it enters into the drain pipe or other plumbing, the upper end of said lint catching bag having a fastening means associated therewith to provide for its securement with the clamping means, and said lint catching bag having a foraminous surface to provide for capturing of any lint draining from the washing machine, but allowing any water to pass therethrough and to be drained away.

2. The lint catching bag of claim 1 wherein said foraminous bag is formed of netting.

3. The lint catching bag of claim 2 wherein said netting is formed of polymer.

4. The lint catching bag of claim 3 wherein said polymer netting forming the lint catching bag is resistant to bleach and other corrosive liquids contained within the draining washing machine water.

5. The lint catching bag of claim 1 wherein said fastening means at the upper end of the bag comprising a drawstring.

6. The lint catching bag of claim 1 wherein said fastening means at the upper end of the bag comprising plastic tie means.

7. The lint catching bag of claim 1 wherein the clamp means provided upon the washing machine drain comprising a metallic clamping device.

8. The lint catching bag of claim 7 wherein said metallic clamping device includes a bolt means provided for reducing the dimension of the clamp as it is tightened around the drain pipe.

9. The lint catching bag of claim 1 wherein the fastening means at the upper end of the bag comprising a plastic tie.

10. The lint catching bag of claim 1 wherein said clamp means attaching to the end of the drain pipe comprising a spring clamp.

11. The lint catching bag of claim 1 wherein a support attaching the upper end of the bag thereto, said support having a base for securement of the upper end of the bag thereon, an integral sleeve extending upwardly from the support base, and said sleeve capable of securement with the proximate end of the drain pipe and for attachment thereto.

12. The lint catching bag of claim 1 wherein said bag when assembled inserting into the upper end of the drain pipe or sewer line.

13. The lint catching bag of claim 1 wherein said bag has dimensions of approximately 12 to 16 inches long, and approximately 2 to 3 inches in width.
